(19) United States
(12) Patent Application Publication
(10) Pub. No.: US 2026/0230515 A1
(43) Pub. Date: Aug. 6, 2026

(54) IP MULTIMEDIA SUBSYSTEM (IMS) CALL EXPERIENCE IMPROVEMENT BASED ON USER FEEDBACK

(71) Applicant: MOTOROLA MOBILITY LLC, WILMINGTON, DE (US)

(72) Inventors: DANIEL C CHISU, Franklin Park, IL (US); MATTHEW DEHECK, Grayslake, IL (US)

(21) Appl. No.: 19/045,672

(22) Filed: Feb. 5, 2025

(51) Int. Cl. H04L 65/80; H04L 65/1069; H04M 7/00; H04W 36/00; H04W 36/30

(52) U.S. Cl. CPC H04L 65/80; H04L 65/1069; H04M 7/0072; H04W 36/00837; H04W 36/304

(57) ABSTRACT

An electronic device provides various techniques for proactively identifying and addressing user dissatisfaction with communication quality of a previous digital protocol call session. In response to detecting termination of a digital protocol call session with second electronic device(s) completed using first call session settings, the electronic device generates and presents, via output device(s), a customer satisfaction user interface including a satisfaction rating affordance for receiving a user satisfaction rating of the digital protocol call session. In response to receiving, via input device(s), a user input to the satisfaction rating affordance indicating being less than fully satisfied, the electronic device triggers performance of a local device check of device parameters associated with call quality. The electronic device identifies device parameter(s) to adjust in an attempt to improve future call quality in response to the dissatisfied user input indicating. The electronic device autonomously adjusts the device parameter(s) during a subsequent call session.

### BACKGROUND

### 1. Technical Field

The present disclosure relates generally to electronic devices that support person-to-person(s) communication, and more particularly to electronic devices that support real-time person-to-person communication including voice/video calls.

### 2. Description of the Related Art

A wireless communications system may include one or multiple network communication devices, such as base stations, that may support wireless communications for one or multiple user communication devices, which are also called user equipment (UE) or other suitable terminology. The wireless communications system may support wireless communications with one or multiple user communication devices by utilizing resources of the wireless communications system, including time resources (e.g., symbols, slots, subframes, frames, or the like) or frequency resources (e.g., subcarriers, carriers, or the like). Additionally, the wireless communications system may support wireless communications (e.g., voice or video digital protocol call sessions) across various radio access technologies, such as including third generation (3G) radio access technology, fourth generation (4G) radio access technology, fifth generation (5G) radio access technology, and other suitable radio access technologies beyond 5G (e.g., sixth generation (6G)). Electronic communication devices such as smartphones enable users to establish video or voice communication sessions using digital protocols with one or more second electronic devices. The user experience during a digital protocol call session is dependent upon many factors. Some of these factors affecting the user experience include the device parameters of each UE that adjust wireless communications with the connected radio access technology. The user experience is also affected by the channel quality between each electronic communication device and the respective radio access technology.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is a simplified block diagram of the electronic device utilizing a user experience call improvement (UECI) module to identify and address customer dissatisfaction after a first call, in order to improve a second call, according to one or more embodiments;

FIG. 3A illustrates the display of the electronic device presenting a call session interface that solicits and responds to levels of user satisfaction following call termination, according to one or more embodiments;

FIG. 3B illustrates the display of the electronic device presenting a second call session interface that solicits and responds to levels of user satisfaction following second call termination, according to one or more embodiments;

FIG. 3C illustrates the display of the electronic device presenting an optional third call session interface that solicits and responds to levels of user satisfaction following call termination with specific notifications regarding adjusted device parameters, according to one or more embodiments;

FIGS. 4A-4B (collectively “FIG. 4”) is a flow diagram presenting a computer-implemented method for improving user experience in a subsequent digital protocol call session by adjusting at least one device parameter associated with communication quality in response to a user input indicating less than full satisfaction of a previous call quality, according to one or more embodiments;

FIGS. 5A-5D (collectively “FIG. 5”) is a flow diagram presenting a computer-implemented method augmenting the method of FIG. 4 with examples of light and deep evaluation techniques for adjusting the one or more device parameters, according to one or more embodiments; and

FIG. 6 is a flow diagram presenting a computer-implemented method augmenting the method of FIG. 5 with a technique for monitoring far end communication quality during the digital protocol communication session, according to one or more embodiments.

### DETAILED DESCRIPTION

According to aspects of the present disclosure, an electronic device, a method, and a computer program product provide various techniques for proactively identifying and addressing user dissatisfaction regarding communication quality during a completed digital protocol communication session by changing device parameter(s) for a subsequent digital protocol communication session. Automated adjustments are made in response to a user dissatisfaction rating. The automated adjustments are intended to avoid or mitigate inappropriate attribution by a user of the electronic device of degraded communication quality being due to limitations or defects of the electronic device. In one or more embodiments, the automated adjustments are made to device parameter(s) that affect a subsequent digital protocol call session that may be an Internet Protocol Multimedia Subsystem (IMS) call using a Session Initiation Protocol (SIP). IMS is a standardized architectural framework for delivering IP multimedia services across vendors and carriers. Historically, in earlier generations of telephony, mobile phones have provided voice call services over a circuit-switched-style network, but in more recent generations, mobile phones increasingly use strictly an IP packet-switched network. Various voice and video over IP technologies are available on smartphones, including: (i) Voice over Long Term Evolved (VoLTE); (ii) Voice over New Radio (VoNR); (iii) Voice over Wi-Fi (VoWiFi); and Video Telephony (VT).

The present disclosure provides an experience improvement for a digital protocol call session (e.g., IMS call) that is responsive to solicited user feedback, recognizing that call quality is a top reason for customer returns of an electronic communication device. Original equipment manufacturers (OEMs) of the electronic communication device generally do not find obvious manufacturing or design deficiencies related to call quality when deployed devices are inspected. Instead, the issues experienced by the user may be external to the deployed device, such as due to network communication coverage, or be readily correctable by changing device parameter(s) at the device. Proactively discovering and intervening to address customer dissatisfaction could financially benefit the OEMs by reducing returns and increasing future purchases, avoid an inconvenience to the users, and generate additional good will for vendors, carriers, and OEMs associated with providing digital protocol calls.

According to one or more embodiments, an electronic device includes one or more input devices and one or more output devices. The electronic device includes a communications subsystem by which the electronic device communicatively connects via a communications network to a video/voice call with one or more second electronic devices. The electronic device has a memory including: (i) a user experience call improvement (UECI) module; and (ii) call session settings. A processor of the electronic device is communicatively coupled to the one or more input devices, one or more output device, the communications subsystem, and the memory. In response to detecting termination of a digital protocol call session, which is completed via the communications subsystem using first call session settings, with at least one second electronic device among the one or more second electronic devices, the processor is configured to cause the electronic device to generate and present, via the one or more output device, a customer satisfaction user interface comprising a satisfaction rating affordance for receiving a user satisfaction rating of the digital protocol call session. In response to receiving, via the one or more input devices, a user input to the satisfaction rating affordance indicating being less than fully satisfied with a previous digital protocol call session, the processor is further configured to cause the electronic device to trigger performance of a local device check of device parameters that are associated with call quality of the previous digital protocol call session. The processor is further configured to cause the electronic device to identify one or more device parameters to adjust in an attempt to improve future call quality in response to the user input indicating being less than fully satisfied. The processor is further configured to cause the electronic device to autonomously adjust the one or more device parameters during a subsequent digital protocol call session.

According to one or more embodiments, a computer-implemented method is provided for proactively identifying and addressing user dissatisfaction regarding communication quality by changing device parameter(s) for a subsequent digital protocol communication session. In response to detecting termination of a digital protocol call session with at least one second electronic device among one or more second electronic devices, where the digital protocol call session was completed using first call session settings, the method includes generating and presenting, via one or more output devices, a customer satisfaction user interface comprising a satisfaction rating affordance for receiving a user satisfaction rating of the digital protocol call session. In response to receiving, via one or more input devices, a user input to the satisfaction rating affordance indicating the user being less than fully satisfied with a previous digital protocol call session, the method includes triggering performance of a local device check of device parameters that are associated with call quality of the previous digital protocol call session. The method includes identifying one or more device parameters to adjust in an attempt to improve future call quality in response to the user input indicating the user being less than fully satisfied. The method includes autonomously adjusting the one or more device parameters during a subsequent digital protocol call session. The method includes generating and presenting, via the one or more output devices, a notification indicating an autonomous adjustment of the one or more device parameters in response to the user input indicating being less than fully satisfied. In one or more embodiments, the notification is general and does not specify the particular device parameter(s) that are adjusted. The general parameter adjustment notification may be made immediately after receiving the user feedback. Alternatively, the general parameter adjustment notification may be made after a subsequent digital protocol call session that receives a user input indicating an improved satisfaction rating as compared to the previous digital protocol session. In one or more embodiments, the notification specifies the particular one or more device parameters that are adjusted. In one or more embodiments, the notification only specifies device parameters that require user action such as connecting another microphone.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

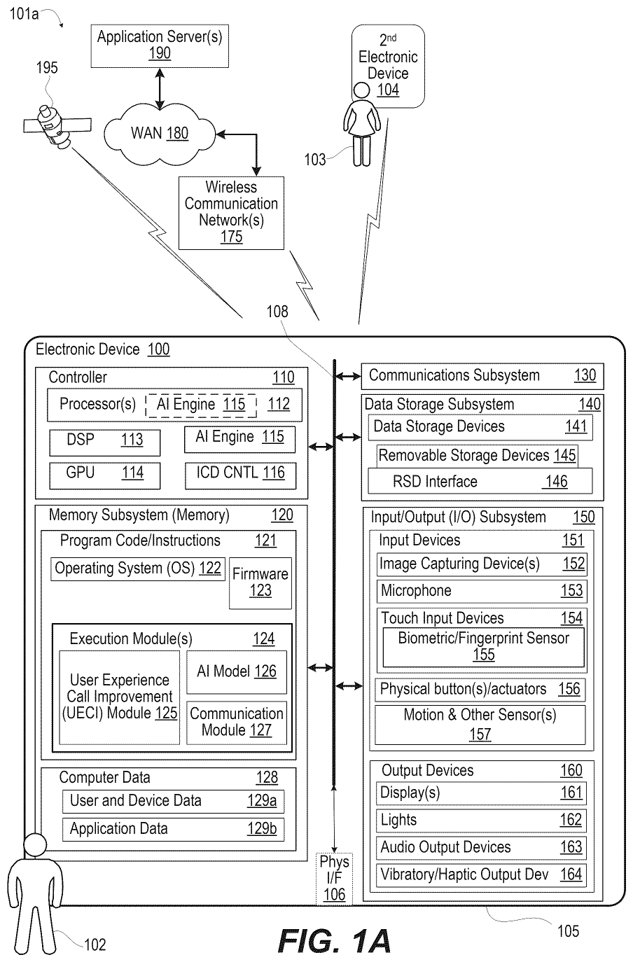

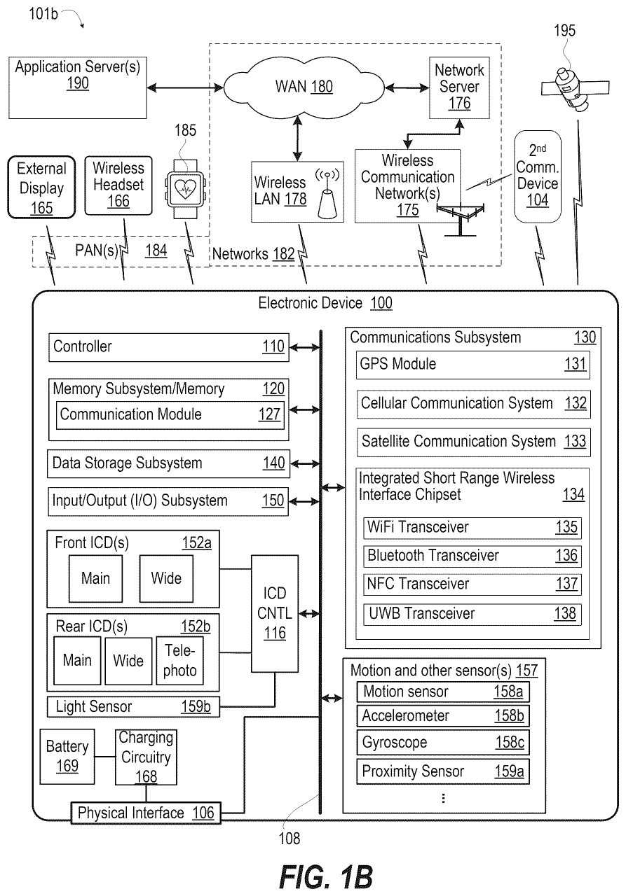

Those of ordinary skill in the art will appreciate that the hardware components and basic configuration depicted in the following figures may vary. For example, the illustrative components within electronic device 100 (FIG. 1A-1B) are not intended to be exhaustive but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 118.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, user experience call improvement (UECI) module 125, which provides the features and operating functionality of the disclosed embodiments when the corresponding program instructions of UECI module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within UECI module 125 and is trained to support the AI features of UECI module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, UECI module 125 can include program instructions for: (i) soliciting a user input indicating a level of customer satisfaction with a digital protocol call session; (ii) automatically adjusting device parameter(s) for a subsequent digital protocol call session to improve customer satisfaction; and (iii) notifying the user of the actions taken or other identified causes of the dissatisfaction. Other features provided by UECI module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of UECI module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of UECI module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

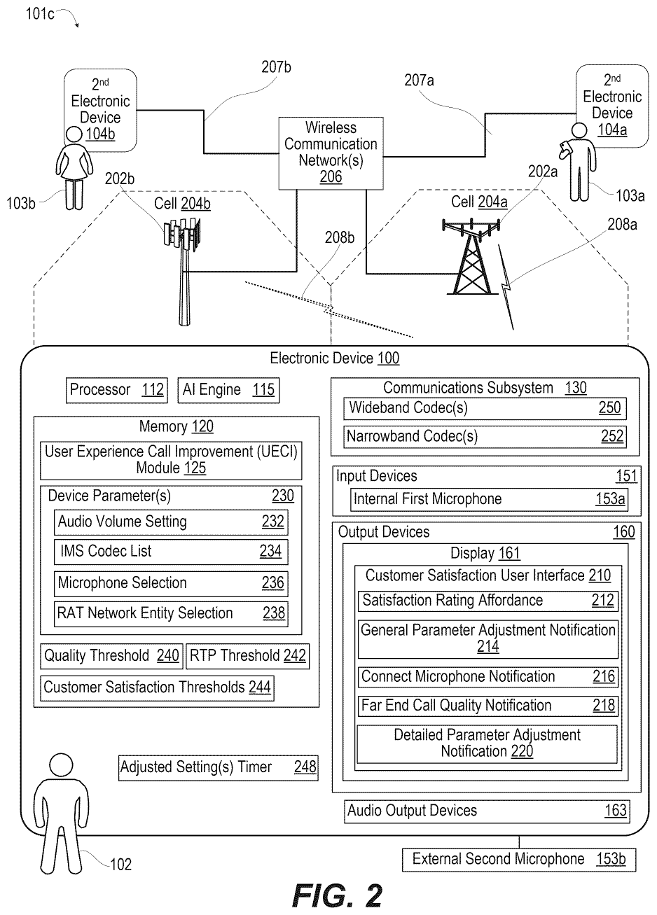

FIG. 2 is a simplified block diagram of electronic device 100 utilizing user experience call improvement (UECI) module 125 to identify and address customer dissatisfaction after a first call with second electronic device 104a used by second user 103a to improve a second call with second electronic device 104b used by second user 103b. For clarity, the first and second calls are with different second electronic devices with corresponding second users. However, each call may have more than one second electronic device. Each second electronic device may be used by one or more second user. Either or both of the first and second call may be an audio call or may be a video call. The first and second calls may be made to two different second electronic devices used by the same user. Each second electronic device may use different types of communication links (e.g., cellular or Wi-Fi) and may be different types of devices. Each of the first and second call may be made to the same one or more second electronic device. Example communications environment 101c includes first radio access technology (RAT) network entity 202a within first cell 204a that is assigned a location area code (LAC) “A” and is communicatively connected to wireless communication network(s) 206. Communications environment 101c includes second RAT network entity 202b within second cell 204b that is assigned LAC “B” and is communicatively connected to wireless communication network(s) 206. Second electronic devices 104a-104b communicate respectively via communication channels 207a-207b with wireless communication network(s) 206. Electronic device 100 may communicatively connect to first and second RAT network entities 202a-202b respectively via local communication channels 208a-208b.

In an example, processor 112 executes UECI module 125 in memory 120 and is configured to cause electronic device 100 to generate and render customer satisfaction user interface 210 for presenting at display 161. Customer satisfaction user interface 210 may include one or more of: (i) satisfaction rating affordance 212; (ii) general parameter adjustment notification 214; (iii) connect microphone notification 216; (iv) far end call quality notification 218; and (v) detailed parameter adjustment notification 220. In one or more embodiments, instead of any one of notifications 214, 216, 218 and 220, customer satisfaction user interface 210 may present general parameter adjustment notification 214 that does not indicate that a particular device parameter is adjusted. Processor 112 further executes UECI module 125 in memory 120 to cause electronic device 100 to adjust device parameter(s) 230 that are related to communication quality. Device parameter(s) 230 may include one or more of: (i) audio volume setting 232; (ii) IMS codec list 234; (iii) microphone selection 236; and (iv) RAT network entity selection 238. Memory 120 includes quality threshold 240, RTP threshold value 242, and customer satisfaction thresholds 244 that are used in evaluating levels of communication quality and customer satisfaction as described below. Electronic device 100 includes adjusted setting(s) timer 248 that is used for resetting adjustments to device parameters as described below. Communications subsystem 130 further includes first codec(s) 250 and second codec(s) 252 that may affect communication quality as perceived by user 102. First codec 250 has a lower bandwidth than second codec 252. In an example, communications system 130 has multiple codecs, including two or more of are narrowband (NB) (e.g., 4 kHz bandwidth), wideband (WB) (e.g., 8 kHz bandwidth), super-wideband (SWB) (e.g., 16 kHz bandwidth), or fullband (FB) (e.g., 20 kHz bandwidth). First and second codecs 250 and 252 may be the same type of codec, such as enhanced voice service (EVS) codecs. First and second codecs 250 and 252 may be different types of codec, such as an EVS codec and an adaptive multi-rate (AMR) codec. In some instances, electronic device 100 may include only one microphone, such as internal first microphone 153a. In other instances, electronic device 100 may include external second microphone 153 that may be electrically connectable or communicatively connectable to electronic device 100 by user 102.

According to aspects of the present disclosure, electronic device 100 includes one or more input devices 151 and one or more output devices 160. Electronic device 100 includes communications subsystem 130 by which electronic device 100 communicatively connects via wireless communications network 206 to a video/voice call with one or more second electronic devices 104a-104b. Electronic device 100 includes memory 120, which includes: (i) user experience call improvement (UECI) module 125; and (ii) call session settings (e.g., device parameter(s) 230). Processor 112 is communicatively coupled to memory 120, communications subsystem 130, one or more input devices 151, and one or more output devices 160. A digital protocol call session using first call session settings is completed via the communications subsystem with at least one second electronic device 104a among one or more second electronic devices 104a-104b. In response to detecting termination of the digital protocol call session, processor 112 is configured to cause electronic device 100 to generate and present, via one or more output devices 160, customer satisfaction user interface 210 including satisfaction rating affordance 212 for receiving a user satisfaction rating of the completed digital protocol call session. In response to receiving, via one or more input devices 151, a user input to satisfaction rating affordance 212 indicating being less than fully satisfied with a previous digital protocol call session, processor 112 is configured to cause electronic device 100 to trigger performance of a local device check of device parameter(s) 230 that are associated with call quality of the previous digital protocol call session. Processor 112 is configured to cause electronic device 100 to identify one or more device parameters 230 to adjust in an attempt to improve future call quality in response to the user input indicating the user being less than fully satisfied. Processor 112 is configured to cause electronic device 100 to autonomously adjust one or more device parameters 230 during a subsequent digital protocol call session with second electronic device 104b.

In one or more embodiments, processor 112 is further configured to cause electronic device 100 to generate and present, via one or more output devices 160, parameter adjustment notification 214, 220 indicating an autonomous adjustment of one or more device parameters 230 in response to the user input indicating the user being less than fully satisfied. In one or more embodiments, the one or more device parameters 230 include audio volume setting 232. Accordingly, in autonomously adjusting one or more device parameters 230 during the subsequent digital protocol call session, processor 112 is further configured to cause electronic device 100 to determine whether audio volume setting 232 of one or more output devices 160 (e.g., audio output device 163) is less than a maximum setting. In response to determining that audio volume setting 232 of one or more output devices 160 is less than a maximum setting, processor 112 is further configured to cause electronic device 100 to increase audio volume setting 232, such as to a selected value above a previous volume setting, including up to a maximum volume setting.

In one or more embodiments, the one or more device parameters 230 includes coder/encoder (codec) selection (e.g., IMS codec list 234) from among a plurality of narrower and/or wider bandwidth codecs. In autonomously adjusting one or more device parameters 230 during the subsequent digital protocol call session, processor 112 is further configured to cause electronic device 100 to determine that the digital protocol call session used first bandwidth codec 250. In response to determining that the digital protocol call session used first bandwidth codec 250, processor 112 is further configured to cause electronic device 100 to utilize second bandwidth codec 252 for the subsequent digital protocol call session. Second bandwidth codec 252 has a wider bandwidth than first bandwidth codec 250.

In one or more embodiments, the one or more device parameters 230 includes microphone selection 236. In autonomously adjusting one or more device parameters 230 during the subsequent digital protocol call session, processor 112 is further configured to cause electronic device 100 to determine whether the one or more input devices 151 has more than one microphone, including first microphone 153a that was used and second microphone 153b that was not used during the digital protocol call session. When there are more than one microphones, processor 112 is further configured to cause electronic device 100 to switch to use second microphone 153b, instead of first microphone 153a, during the subsequent digital protocol call session.

In one or more particular embodiments, the one or more device parameters 230 includes microphone selection 236. In autonomously adjusting one or more device parameters 230 during the subsequent digital protocol call session, processor 112 is further configured to cause electronic device 100 to determine that one or more input devices 151 includes only first microphone 153a that was used during the digital protocol call session. Processor 112 is further configured to cause electronic device 100 to identify that electronic device 100 can be communicatively coupled to external second microphone 153b. Processor 112 is further configured to cause electronic device 100 to present connect microphone notification 216, via one or more output devices 160, to connect second microphone 153b to electronic device 100. In an example, user 102 may respond to connect microphone notification 216 by plugging an electrical cord of second microphone 153 into an electrical port or receptacle of electronic device 100. In another example, user 102 may initiate Bluetooth pairing of second microphone 153b to electronic device 100. Processor 112 is further configured to cause electronic device 100 to use connected second microphone 153b for the subsequent digital protocol call session.

In one or more embodiments, one or more device parameters 230 includes radio access technology (RAT) network entity selection 238. In autonomously adjusting one or more device parameters 230 during the subsequent digital protocol call session, processor 112 is further configured to cause electronic device 100 to communicatively connect, via communications subsystem 130, with first RAT network entity 202a during the initial digital protocol call session. In response to determining that second RAT network entity 202b within a connection range of electronic device 100 satisfies communication quality criteria for a handover, processor 112 is further configured to cause electronic device 100 to autonomously adjust one or more device parameters 230 during the subsequent digital protocol call session by triggering handover of the digital protocol call session to second RAT network entity 202b for the subsequent digital protocol call session. In one or more embodiments, the adjustments to the one or more device parameters 230 may be used in additional subsequent digital protocol call sessions. As described herein, continued use of the adjustments to the one or more device parameters 230 may terminate for one or more factors such as a time limit, leaving a current location or serving network entity, or receiving a subsequent indication of customer dissatisfaction.

In one or more embodiments, processor 112 is further configured to cause electronic device 100 to determine communication quality experienced by electronic device 100 with wireless communications network 206. Processor 112 is further configured to cause electronic device 100 to monitor real time protocol (RTP) packet loss of received data from second electronic device 104a. Processor 112 is further configured to cause electronic device 100 to determine that the RTP packet loss is greater than RTP threshold value 242 while a downlink communication quality detected by electronic device 100 is greater than a quality threshold value. In response to determining that RTP packet loss is greater than a RTP threshold value while the downlink communication quality detected by electronic device 100 is greater than a quality threshold value, processor 112 is further configured to cause electronic device 100 to generate and present far end call quality notification 218, via one or more output devices 160 (e.g., display 161), indicating that a detected degraded quality of the digital protocol call session was external to electronic device 100. The far end call quality notification 218 may specify that the detected degraded quality was influenced/affected by poor communication quality with wireless communications network 206 experienced by second electronic device 104a that participated in the digital protocol call session. Further, the far end call quality notification 218 may further indicate/include that the detected degraded quality was beyond mitigation by adjusting the one or more device parameters 230.

In one or more embodiments, in response to determining that subsequent digital protocol call session is being initiated in a second location (e.g., second cell 204b with LAC “B”) that is different from a first location (e.g., first cell 204a with LAC “A”) of the digital protocol call session, processor 112 is further configured to cause electronic device 100 to reset the call session setting to first (or default) device settings.

In one or more embodiments, processor 112 is further configured to cause electronic device 100 to start adjusted setting(s) timer 248, contemporaneously with autonomously adjusting one or more device parameters 230 in preparation for the subsequent digital protocol call session. In response to expiration of adjusted setting(s) timer 248, processor 112 is further configured to cause electronic device 100 to remove the adjustment of one or more device parameters 230.

In one or more embodiments, in response to determining that the subsequent digital protocol call session is being initiated, processor 112 is further configured to cause electronic device 100 to monitor communication quality associated with the adjustment of one or more device parameters 230. Processor 112 is further configured to cause electronic device 100 to remove the adjustment of one or more device parameters 230 in response to the communication quality being degraded below a quality threshold.

In one or more embodiments, in response to determining that the subsequent digital protocol call session is being terminated, processor 112 is further configured to cause electronic device 100 to generate and present, via one or more output devices 160, second customer satisfaction user interface 210 including second satisfaction rating affordance 212 for receiving a second user satisfaction rating of the subsequent digital protocol call session. In response to receiving, via one or more input devices 151, a second user input to second satisfaction rating affordance 212 indicating being less than fully satisfied, processor 112 is further configured to cause electronic device 100 to remove the adjustment of one or more device parameters 230. In one or embodiments, processor 112 is further configured to cause the electronic device 100 to adjust one or more device parameters 230 that were not previously adjusted. In one or more embodiments, processor 112 is further configured to selectively remove adjustment of one or more device parameters 230 based on empirically or deterministically assessing that conditions have changed sufficiently to make the adjustment ineffective to improve call quality.

In one or more particular embodiments, in response to the communication quality being degraded below a quality threshold, processor 112 is further configured to cause electronic device 100 to trigger performance of a local device check of device parameters that are associated with call quality of the previous digital protocol call session. Processor 112 is further configured to cause electronic device 100 to identify one or more second device parameters 230 to adjust in an attempt to improve future call quality in response to the user input indicating the user being less than fully satisfied. Processor 112 is further configured to cause electronic device 100 to autonomously adjust one or more second device parameters 230 during (or prior to) a second subsequent digital protocol call session.

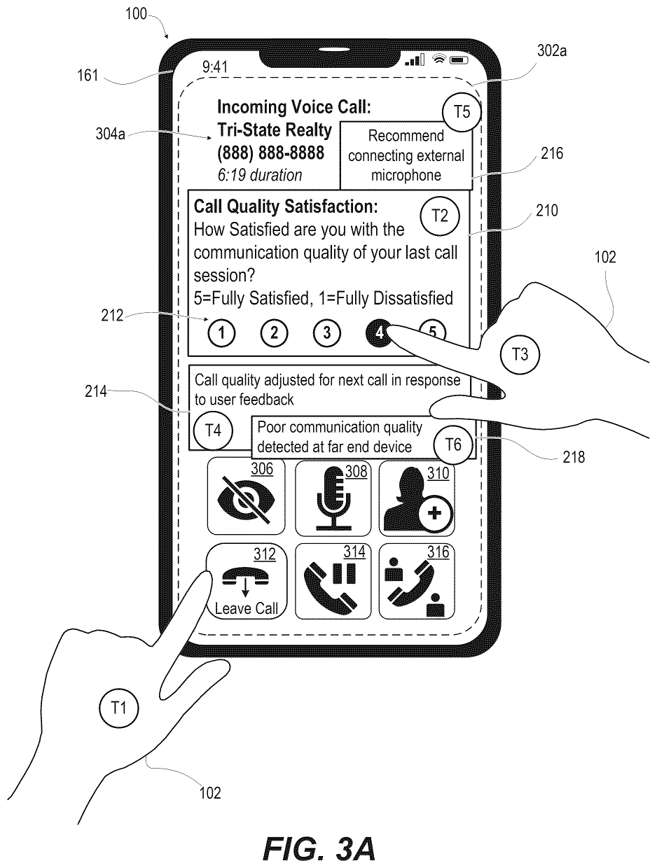

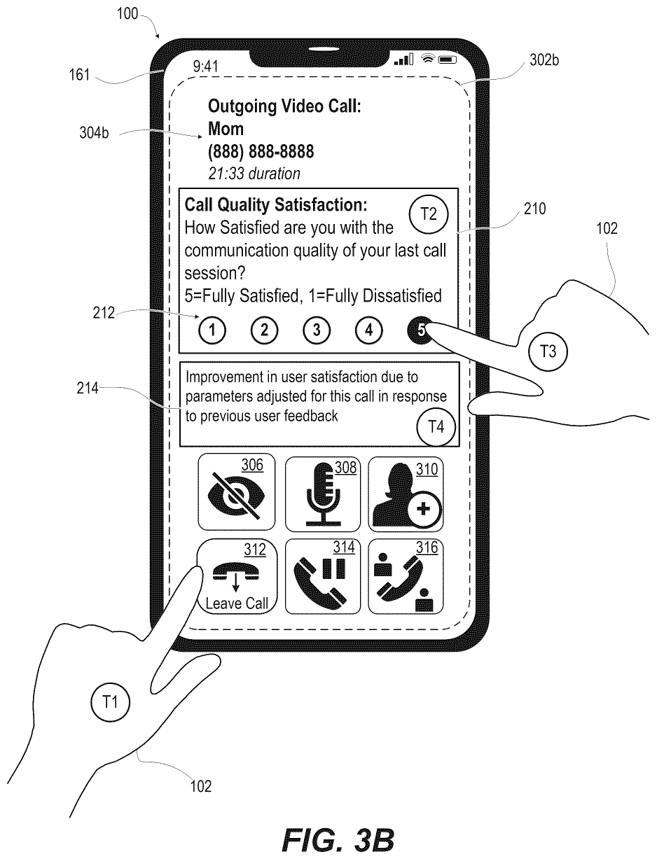

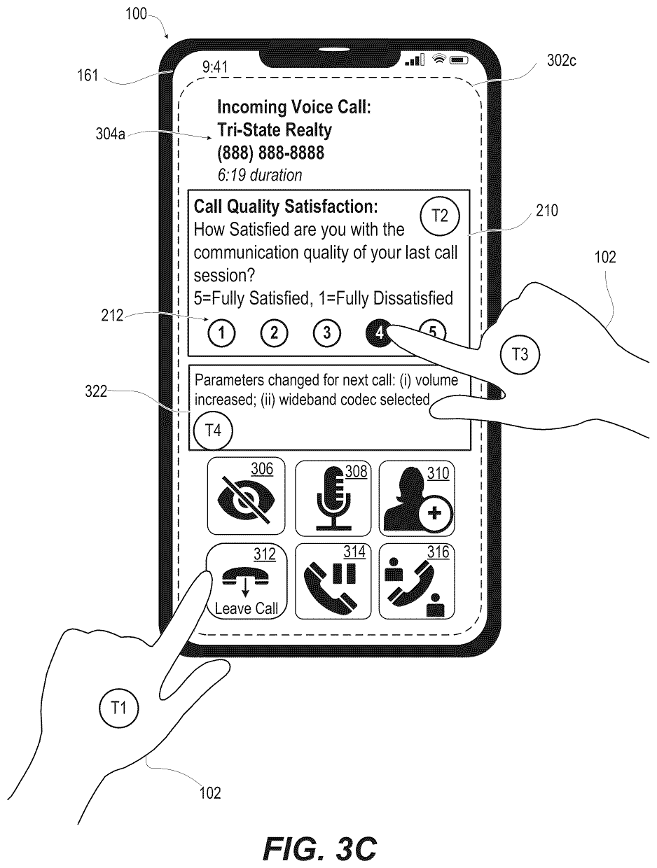

FIG. 3A illustrates display 161 of electronic device 100 presenting first call session interface 302a that upon call termination solicits and responds to levels of user satisfaction. Call session interface 302a includes identification information 304a for second user(s)/second electronic device(s). Call session interface 302a includes call controls such as: (i) camera toggle control 306; (ii) microphone toggle control 308; (iii) add second electronic device control 310; (iv) leave call control 312; (v) hold call control 314; and (vi) transfer call control 316. At a first time “T1”, user 102 activates leave call control 314. In response to termination of the digital protocol call session, electronic device 100 initiates improvement to a user experience at a second time “T2” by generating and presenting customer satisfaction user interface 210 that includes satisfaction rating affordance 212 such as a 1-to-5 rating scale. In an example, rating “5” is fully satisfied. Rating “4” is less than fully satisfied, triggering a first level customer satisfaction threshold (e.g., less than 5) warranting a light evaluation for adjusting device parameter(s). Rating “3” is “somewhat satisfied and somewhat dissatisfied and can correspond to a second customer satisfaction threshold (e.g., less than 4) warranting a deep evaluation for adjust device parameter(s) and identifying external factors. Rating “2” is “mostly dissatisfied”. Rating “1” is fully dissatisfied. At a fourth time “T4”, general parameter adjustment notification 214 is presented on display 161 indicating that parameters have been adjusted in response to the user input of being less than fully satisfied. In one or more embodiments, presentation of general parameter adjustment notification 214 may be deferred until succeeding in improvement to call quality during a subsequent call session as depicted in FIG. 3B. In one or more embodiments, instead of presentation of general parameter adjustment notification 214, electronic device 100 may present specific notifications such as depicted in FIGS. 3A and 3C. In an example, at fifth time “T5”, connect microphone notification 216 is presented on display 161 to recommend manual connection or coupling of an external microphone to improve call quality. In another example, at sixth time “T6”, far end call quality notification 218 is presented on display 161 to indicate at least part of call quality degradation is due to poor communication coverage experienced by the second electronic device.

FIG. 3B illustrates display 161 of electronic device 100 presenting second call session interface 302b that upon second call termination, which is subsequent to the first call of FIG. 3A, solicits and responds to levels of user satisfaction. Call session interface 302b includes identification information 304b for second user(s)/second electronic device(s). Second call session interface 302b is generally as described for first call session interface 302a of FIG. 3A with the following exceptions. Instead of presenting general parameter adjustment notification 214 (FIG. 3A) immediately following receipt of user feedback, second call session interface 302b presents general parameter adjustment notification 214 after receiving user feedback indicating an improved satisfaction rating as compared to the previous digital protocol session.

FIG. 3C illustrates display 161 of electronic device 100 presenting optional third call session interface 302c that upon first call termination, solicits and responds to levels of user satisfaction. Call session interface 302c includes identification information 304a for second user(s)/second electronic device(s). Second call session interface 302c is generally as described for first call session interface 302a of FIG. 3A with the following exceptions. Instead of presenting general parameter adjustment notification 214 (FIG. 3A), third call session interface 302c presents specific notification 322 that specifies digital parameter(s) that are adjusted.

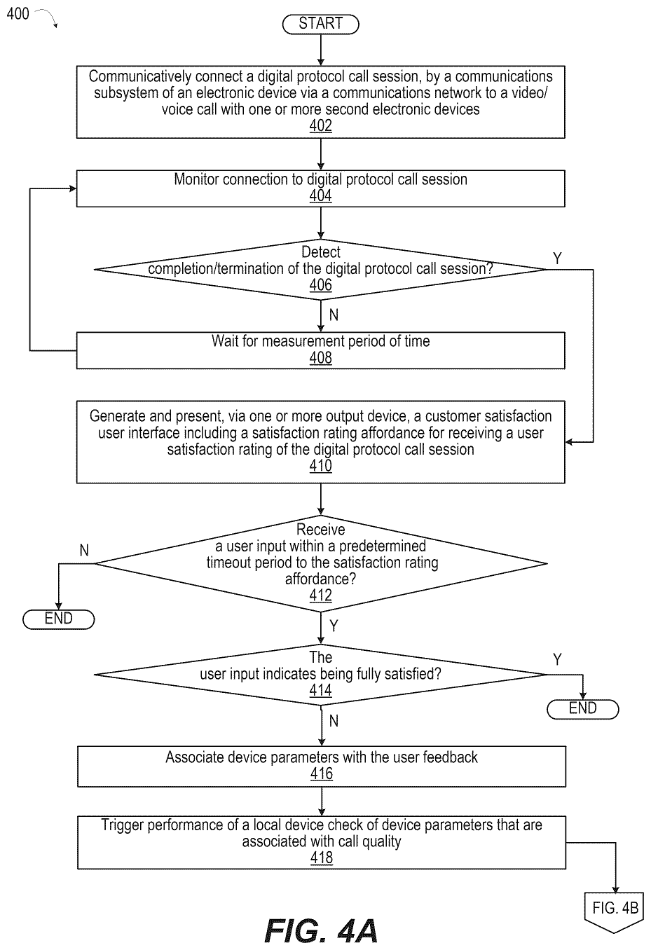

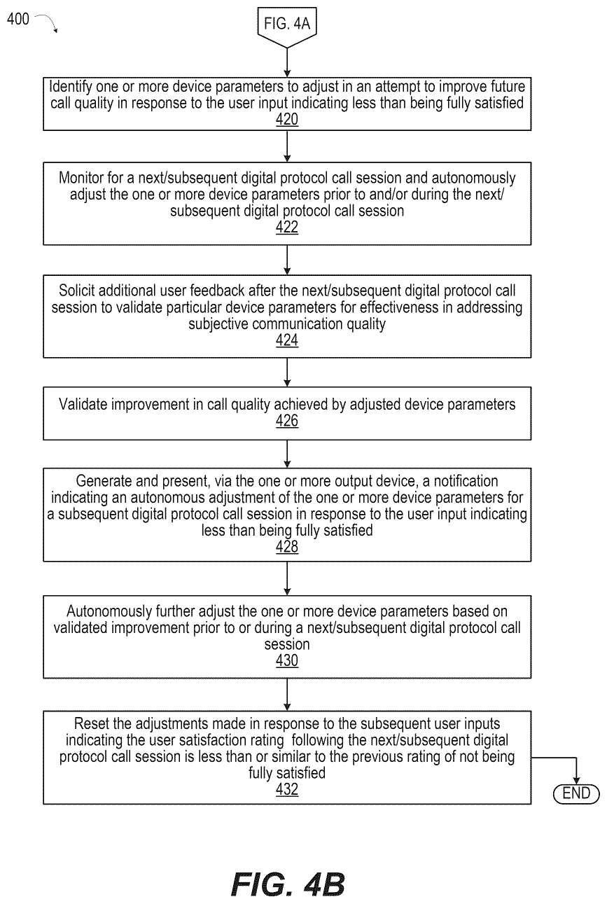

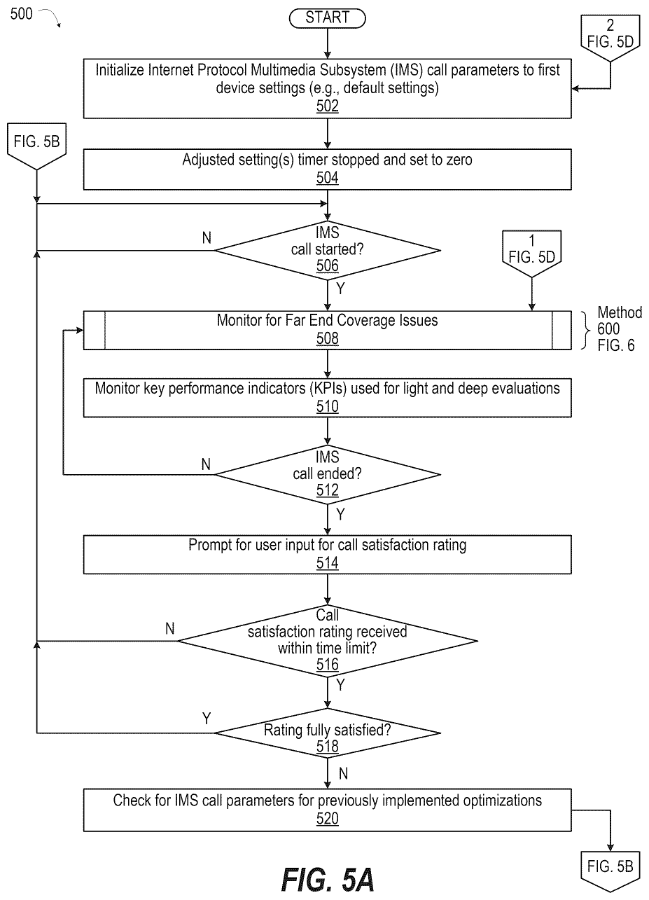

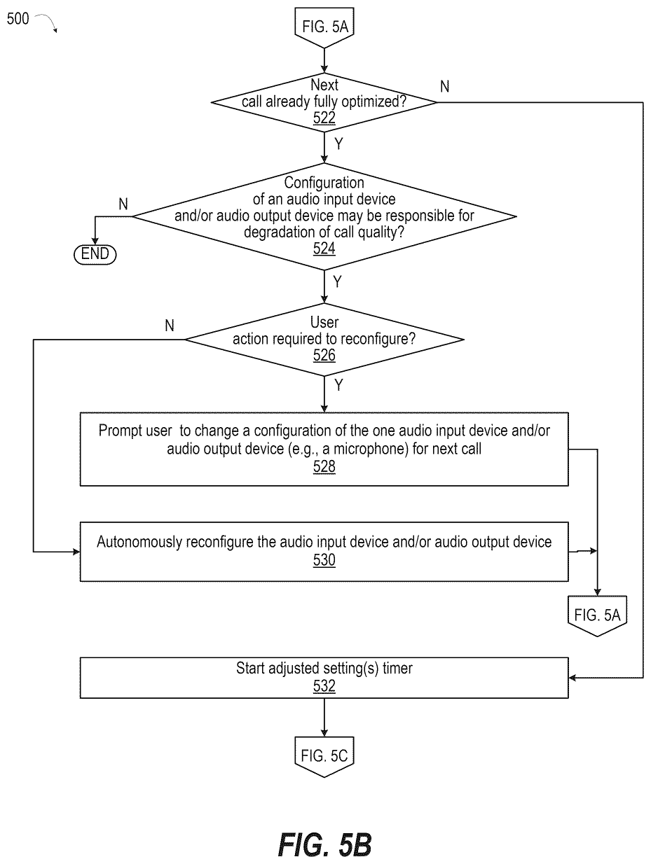

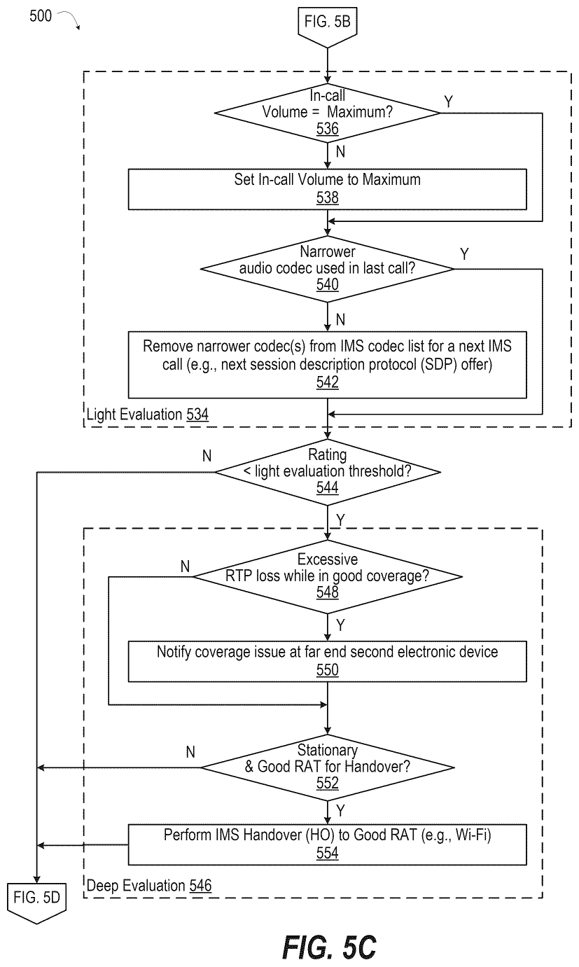

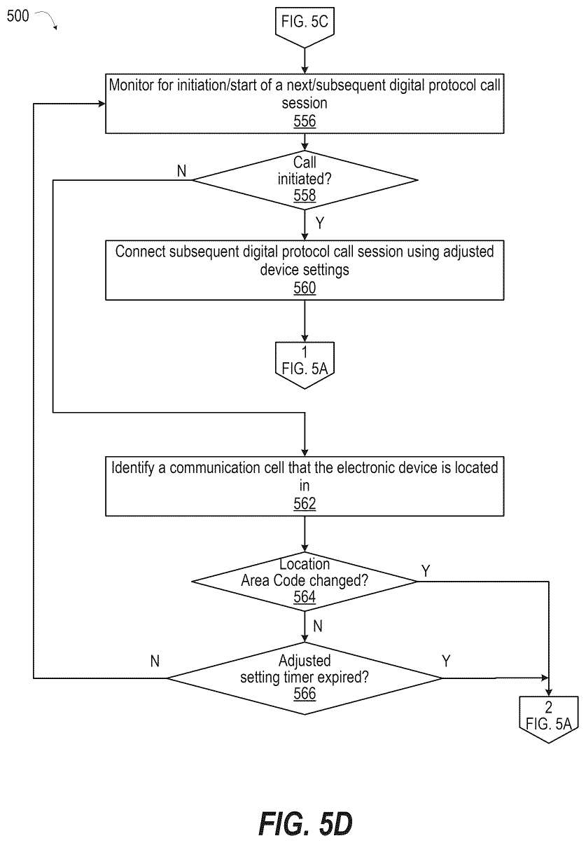

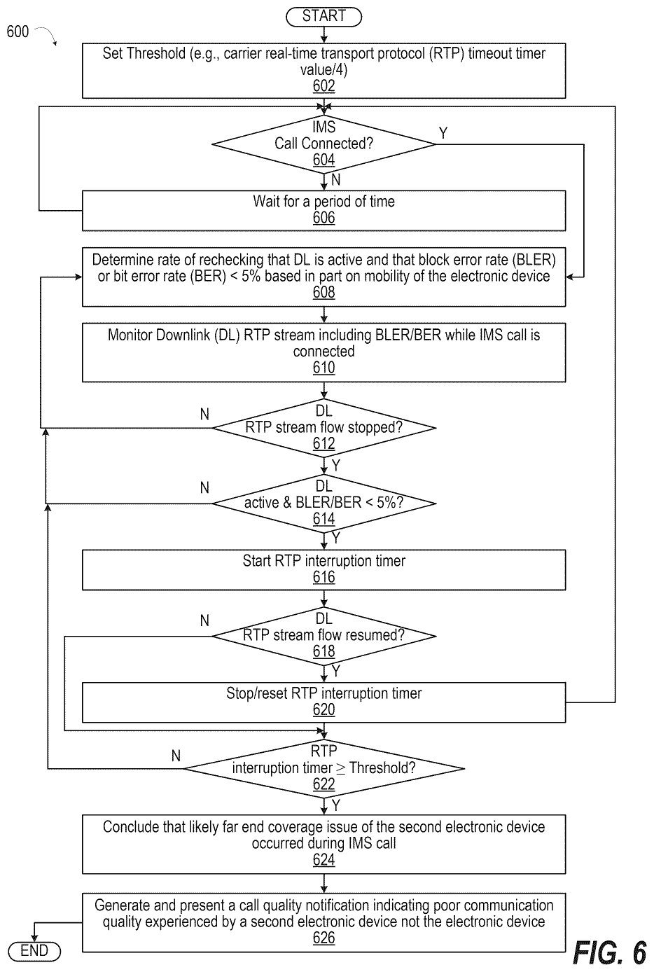

FIGS. 4A-4B (collectively “FIG. 4”) is a flow diagram presenting computer-implemented method 400 for improving user experience in a subsequent digital protocol call session by adjusting at least one device parameter associated with communication quality in response to a user input indicating less than full satisfaction following completion of a previous digital protocol call session. FIGS. 5A-5C (collectively “FIG. 5”) is a flow diagram presenting computer-implemented method 500 augmenting method 400 of FIG. 4 with examples of light and deep evaluation techniques for adjusting the one or more device parameters. FIG. 6 is a flow diagram presenting computer-implemented method 600 augmenting method 500 (FIG. 5) with a technique for monitoring far end communication quality during the digital protocol communication session. The descriptions of method 400 (FIG. 4), method 500 (FIG. 5), and method 600 (FIG. 6) are provided with general reference to the specific components illustrated within the preceding FIGS. 1A-1B and 2 , and 3A-3C. Specific components referenced in method 400 (FIG. 4), method 500 (FIG. 5), and method 600 (FIG. 6) may be identical or similar to components of the same name used in describing preceding FIGS. 1A-1B and 2 , and 3A- 3C. In one or more embodiments, controller 110 (FIG. 1A) configures electronic device 100 (FIGS. 1A-1B) or a similar computing device to provide the described functionality of method 400 (FIG. 4), method 500 (FIG. 5), and method 600 (FIG. 6).

With reference to FIG. 4A, method 400 includes communicatively connecting a digital protocol call session, by a communications subsystem of an electronic device via a communications network to a video/voice call with one or more second electronic devices (block 402). Method 400 includes monitoring connection to digital protocol call session (block 404). Method 400 includes determining whether the digital protocol call session is completed/terminated (decision block 406). In response to determining that termination of the digital protocol call session is not detected, method 400 includes waiting for a measurement period of time (block 408). Then method 400 returns to block 404. In response to determining that the digital protocol call session has completed/been terminated, method 400 includes generating and presenting, via one or more output devices, a customer satisfaction user interface including a satisfaction rating affordance for receiving a user satisfaction rating of the digital protocol call session (block 410). Method 400 includes determining whether a user input to the satisfaction rating affordance is received, via one or more input devices, within a predetermined timeout period (decision block 412). In response to not receiving a user input within the predetermined timeout period, method 400 ends. In response to receiving a user input, method 400 includes determining whether the user input to the customer satisfaction affordance indicates the user being fully satisfied (decision block 414). In response to the user input indicating the user being fully satisfied, method 400 ends. In response to the user input indicating the user not being fully satisfied, method 400 may include associating device parameters with the user feedback (block 416). In an example, the user may feedback may indicate poor audio output at the electronic device, poor audio output at the second electronic device, poor audio input at the electronic device, poor decoding of received audio, etc. Corrective actions may be associated with particular symptoms contained in the user feedback. Method 400 includes triggering performance of a local device check of device parameters that are associated with call quality (block 418). In an example, the performance check identifies device parameter settings that are applicable to a particular IMS mode of communicating and applicable to a configuration of the electronic device. Then method 400 proceeds to block 420 of FIG. 4B.

In response to the user input indicating the user not being fully satisfied in decision block 414, method 400 may optionally include soliciting user feedback regarding aspects of call quality that were dissatisfying. In an example, the user may be prompted to type or speak a freeform explanation. In another example, the user may be given specific options to select, such as the user could not hear the other participant, the other participant could not consistently hear the user, speech by the other participant was garbled or intermittent, the speech by the other participant sounded thin with no resonance. It is however appreciated that method 400 may not include the device soliciting any further information from the user.

With reference to FIG. 4B, method 400 includes identifying one or more device parameters to adjust in an attempt to improve future call quality in response to the user input indicating being less than fully satisfied (block 420). In an example, the electronic device may pick a subset of the device parameters that is the most likely culprit for degrading communication quality. Method 400 includes monitoring for a next/subsequent digital protocol call session and autonomously adjusting the one or more device parameters prior to and/or during the next/subsequent digital protocol call session (block 422). Method 400 may include soliciting additional user feedback after the next/subsequent digital protocol call session to validate particular device parameters for effectiveness in addressing subjective communication quality (block 424). Method 400 may include validating improvement in call quality achieved by the adjusted device parameters (block 426). In an example, the electronic device is capable of testing communication with a network entity prior to the next/subsequent digital protocol call session. In another example, the electronic device is capable of testing communication with the network entity and the second electronic device during initiation of the next/subsequent digital protocol call session. Method 400 includes generating and presenting, via the one or more output devices, a notification indicating an autonomous adjustment of one or more device parameters for a subsequent digital protocol call session in response to the user input indicating being less than fully satisfied (block 428). In one or more embodiments, the electronic device may present the notification after the subsequent digital protocol call session in response to receiving a user input indicating being less than fully satisfied. The notification provides a general explanation that autonomous adjustments have been made to the device (or the device parameters) to improve call quality. Method 400 may include autonomously further adjusting the one or more device parameters based on validated improvement prior to or during a next/subsequent digital protocol call session (block 430). Method 400 includes resetting the adjustments made in response to the subsequent user inputs indicating the user satisfaction rating following the next/subsequent digital protocol call session is less than or similar to the previous rating of not being fully satisfied (block 432). Then method 400 ends.

With reference to FIG. 5A, method 500 includes initializing Internet Protocol Multimedia Subsystem (IMS) call parameters to first device settings (i.e., default settings) (block 502). Method 500 includes stopping an adjusted setting(s) timer, if the timer is running, and/or (re)setting the adjusted setting(s) timer to zero (block 504). Method 500 includes determining whether a digital protocol call session (i.e., an IMS call) is started (decision block 506). In response to determining that no IMS call has started, method 500 returns to decision block 506.

In response to determining that an IMS call has started in decision block 506, method 500 may include monitoring for far end coverage issues that may affect user experience during a digital protocol call session but may be external to effects of adjusting device parameter(s) of the electronic device (block 508). Method 600 of FIG. 6 provides an example of monitoring far end coverage issues that affect an uplink data transmission by a second electronic device.

With continuing reference to FIG. 5A, method 500 includes monitoring key performance indicators (KPIs) used for light and deep evaluations (block 510). Examples of the light evaluation 534 and deep evaluation 546 are described below with regard to FIG. 5C. With continuing reference to FIG. 5A, method 500 includes determining whether the IMS call has ended (decision block 512). In response to determining that the IMS call has not ended, method 500 returns to decision block 506. In response to determining that the IMS call has ended, method 500 includes presenting a user interface that prompts for a user input for a call satisfaction rating (block 514). Method 500 includes determining whether a call satisfaction rating is received within a predetermined time limit (decision block 516). In response to determining that a call satisfaction rating is not received within the predetermined time limit (i.e., user chooses to not provide a user input), method 500 includes returning to decision block 506. In response to determining that a call satisfaction rating is received, method 500 includes determining whether the call satisfaction rating indicates the user being fully satisfied (decision block 518). In response to determining that the call satisfaction rating indicates the user being fully satisfied, method 500 includes returning to decision block 506. In response to determining that the call satisfaction rating does not indicate being fully satisfied, method 500 includes checking for IMS call parameters for previously implemented optimizations (i.e., adjusted device parameter(s)) (block 520). Then method 500 proceeds to block 522 of FIG. 5B.

With reference to FIG. 5B, method 500 includes determining whether the device parameter(s) for a subsequent call are already fully optimized (decision block 522). In response to determining that the device parameter(s) for a subsequent call are already fully optimized, method 500 includes determining whether a configuration of an audio input device and/or audio output device may be responsible for degradation of call quality (decision block 524). In response to determining that the configuration of audio input device and/or audio output device may not be responsible for degradation of call quality, method 500 ends. In response to determining that the configuration of audio input device and/or audio output device may be responsible for degradation of call quality, method 500 includes determining whether changing the configuration of the audio input device and/or audio output device requires user action to reconfigure (decision block 526). In response to determining that changing the configuration requires user action to reconfigure, method 500 may include prompting a user via one or more output devices of the electronic device to change a configuration of the audio input device and/or the audio output device (e.g., a microphone) for next call (block 528). In an example, the user may be prompted to attach a headset rather than using an integral microphone/speaker. In response to determining that changing the configuration does not require user action to reconfigure, method 500 may include autonomously reconfiguring the audio input device and/or audio output device (block 530). In response to determining that the configuration of audio input device and/or audio output device may not be responsible for degradation of call quality in decision block 524 or after performing one of blocks 528 or 530, hen method 500 returns to decision block 506 of FIG. 5A.

In one or more embodiments, method 500 may include discovering and adjusting only one device parameter that may be optimized for a subsequent digital protocol call session. In one or more embodiments, method 500 may include discovering and adjusting more than one device parameter for a subsequent digital protocol call session. In one or more embodiments, the one or more device parameters includes or wholly corresponds to microphone selection. In autonomously adjusting the one or more device parameters during the subsequent digital protocol call session, method 500 may further include determining that the one or more input devices includes only a first microphone that was used during the digital protocol call session. Method 500 may further include identifying that the electronic device can be communicatively coupled to an external second microphone. Method 500 may further include presenting a notification, via the one or more output devices, to connect the second microphone to the electronic device. Method 500 may further include configuring the electronic device to use the connected second microphone for the subsequent digital protocol call session. In an example, the terminated digital protocol call session (e.g., IMS call) may include the electronic device using an integrated first microphone with no other microphone being currently accessible for the electronic device to autonomously select for a subsequent digital protocol call session. The electronic device may include an interface that supports connecting an external second microphone.

With continued reference to FIG. 5B, in response to determining that the device parameter(s) for a subsequent call is not already fully optimized in decision block 522, method 500 includes starting the adjusted setting(s) timer (e.g., optimization timer) (block 532). Then method 500 proceeds to performing a light evaluation (block 534) of FIG. 5C.

With reference to FIG. 5C, method 500 may include performing a light evaluation (block 534) that includes performing processes presenting in one or more of blocks 536, 538, 540 and 542. Method 500 may include determining whether the device parameter for in-call audio volume is equal to a maximum setting for audio volume (decision block 536). In response to determining that in-call audio volume is not set to the maximum setting (i.e., is less than the maximum setting), method 500 may include increasing the in-call audio volume, such as to the maximum setting for a subsequent IMS call (block 538).

In response to determining that in-call audio volume is set to the maximum setting in decision block 536 or after performing block 538, method 500 includes determining whether a narrower audio or video coder/decoder (codec) was used during the last IMS call than an available wider audio or video codec(decision block 540). In response to determining that a narrower audio or video codec was not used during the last IMS call, method 500 may include removing the narrower codec(s) from an IMS audio or video codec list for a next IMS call (e.g., next session description protocol (SDP) offer) (block 542). The IMS audio or video codec list will then consist of wider codec(s) for being used in the next IMS call, which may improve communication quality.

In response to determining that a narrower audio or video codec was not used during the last IMS call in decision block 540 or after performing block 542, method 500 may include determining whether the customer satisfaction rating was less than a light evaluation threshold (decision block 544). In response to determining that the customer satisfaction rating was not less than the light evaluation threshold, method 500 proceeds to block 556 of FIG. 5C to wait for a next/subsequent digital protocol call session.

In response to determining that the customer satisfaction rating was less than the light evaluation threshold, method 500 includes performing deep evaluation (block 546) that may include performing processes provided in one or more of blocks 548, 550, 552, and 554. Method 500 may include determining whether excessive real-time packet data (RTP) loss occurred during the IMS call while the electronic device was in good communication coverage with the assigned radio access technology (decision block 548). In response to determining that excessive RTP loss occurred during the IMS call while the electronic device was in good communication coverage, method 500 may include notifying the user via the output device(s) of the electronic device of a coverage issue at a far end to the second electronic device (block 550). The information necessary for supporting block 550 is described in greater detail in method 600 (e.g., block 628) of FIG. 6. The notification indicates that at least in part the far end coverage issue affected communication quality and was outside of the control of the electronic device.

In response to determining that excessive RTP loss did not occur during the IMS call while the electronic device was in good communication coverage in decision block 548 or after notifying the user in block 550, method 500 may include determining whether the electronic device is essentially stationary with an alternative radio access technology (RAT) available for a handover (decision block 552). In response to determining that the electronic device is essentially stationary with an alternative “good” RAT available for a handover, method 500 may include performing an IMS handover (HO) to the alternative good RAT (e.g., Wi-Fi) (block 554). In response to determining that the electronic device is essentially stationary with an alternative “good” RAT available for a handover in decision block 550 or after forming IMS handover in block 554, method 500 proceeds to block 556 of FIG. 5C to wait for a next/subsequent digital protocol call session.

With reference to FIG. 5D, method 500 includes monitoring for initiation/start of a next/subsequent digital protocol call session (block 556). Method 500 includes determining whether a next/subsequent digital protocol call session is initiated/started (decision block 558). In response to determining that the next/subsequent digital protocol call session is initiated/started, method 500 includes connecting subsequent digital protocol call session using adjusted device settings (block 560). Then method 500 returns to block 508 of FIG. 5A to begin monitoring far end communication quality. In response to determining that the next/subsequent digital protocol call session is not initiating/starting, method 500 continues to monitor, which includes continuing to perform the digital protocol procedures to camp on a serving network entity and to be ready to change serving network entity based on factors such as mobility and capacity of the network entities.

Method 500 includes identifying a communication cell that the electronic device is located in (block 562). The communication cell is identified by a location area code. Method 500 includes determining whether the location area code for a servicing radio access technology has changed (decision block 564). During an initial iteration or loop of method 500, the device parameter(s) are in the first device settings awaiting a first digital protocol call session. Changing location area codes does not result in a change in the device parameter(s) that are already in the first device settings. However, a change in location area may be subsequently used to reset operation of method 500 because different radio access technologies at different locations may require no optimizations or different device parameters. In these subsequent iterations, method 500 may include determining whether the digital protocol call session (e.g., IMS call) is being initiated in a second location that is different from a first location where the device parameter(s) were adjusted or optimized. An indication of the change in location may be based on a change in location area code. In response to determining in decision block 564 that location area code has changed, method 500 returns to block 502 of FIG. 5A to reset the call session setting to the first device settings (i.e., default device settings). In response to determining that location area code has not changed, method 500 may include determining whether an adjusted setting(s) timer (e.g., optimization timer) is expired (i.e., exceeding a timer threshold) (decision block 566). In certain situations, changes in communication channel quality or other factors may occur over a period of time that warrant resetting operation of method 500.

During an initial iteration or loop of method 500, the adjusted setting(s) timer has not been started, and the device parameter(s) remain in the first device settings with adjusted setting(s) timer not started and set to zero. In response to determining that the adjusted setting timer is expired, method 500 returns to block 502 of FIG. 5A to reset the device parameters. In response to determining that an adjusted setting(s) timer is not expired in decision block 566, method 500 returns to block 556 to continue monitoring for the initiation/start of the next/subsequent digital protocol call session.

In one or more embodiments, the one or more device parameters include radio access technology (RAT) network entity selection. In autonomously adjusting the one or more device parameters during the subsequent digital protocol call session, method 500 includes communicatively connecting, via the communications subsystem of the electronic device, with a first radio access technology (RAT) network entity during the digital protocol call session. In response to determining that a second RAT network entity within a connection range of the electronic device satisfies communication quality criteria for a handover, method 500 includes autonomously adjusting the one or more device parameters during the subsequent digital protocol call session by triggering handover of the digital protocol call session to the second RAT network entity for the subsequent digital protocol call session.

With regard to FIG. 6, method 600 includes setting a real-time transport protocol (RTP) threshold value (e.g., carrier RTP timeout timer value/4) (block 602). Method 600 includes determining whether the digital protocol call session is connected (decision block 604). In response to determining that the digital protocol call session is not connected, method 600 includes waiting for a period of time (block 606). Then method 600 returns to decision block 604. In response to determining that the digital protocol call session is connected, method 600 includes determining rate of rechecking that downlink (DL) is active and that block error rate (BLER) or bit error rate (BER) rate are less than 5%, which may be reduced when the electronic device is stationary and will remain within the same cell (block 608). BLER is typically used while on cellular RAT for WWAN. BER is typically used while on WLAN. BLER/BER rate of 5% is an example. The threshold may be higher or lower threshold values such as 6%. Method 600 includes monitoring DL RTP stream including BLER/BER at the rate of rechecking while IMS call is connected (block 610). Method 600 includes determining whether the DL RTP stream flow stopped (decision block 612). In response to determining that the DL RTP stream flow has not stopped, method 600 returns to block 608. In response to determining that the DL RTP stream flow has stopped, method 600 includes determining whether both the DL is active and BLER/BER is less than 5% (decision block 614). In response to determining that either the DL is not active or that BLER/BER is not less than 5% (i.e., equal to or greater than 5%), then method 600 returns to block 608. In response to determining that both the DL is active and that BLER/BER is less than 5%, method 600 includes starting an RTP interruption timer (block 616).

Method 600 includes determining whether the DL RTP stream flow has resumed (decision block 618). In response to determining that the DL RTP stream flow has resumed, method 600 includes stopping/resetting the RTP interruption timer (block 620). Then method 600 returns to block 604. In response to determining that the DL RTP stream flow has not resumed, method 600 includes determining whether the RTP interruption timer value is equal to or greater than the RTP threshold value (decision block 622). In response to determining that the RTP interruption timer value is not equal to or greater than (i.e., less than) the RTP threshold value, method 600 returns to block 604. In response to determining that the RTP interruption timer value is equal to or greater than the RTP threshold value, method 600 includes concluding that a likely far end coverage issue of the second electronic device occurred during the IMS call (block 624). Method 600 includes generating and presenting a call quality notification, via the one or more output devices, indicating that a detected degraded quality of the digital protocol call session was influenced/affected by poor communication quality with the communications network experienced by a second electronic device that participated in the digital protocol call session, and not the electronic device (block 626). In an example, the notification may include “likely transmission issue at the far end (i.e., second electronic device) and call may get dropped if condition is prolonged.” Then method 600 ends.

In one embodiment, method 600 may include determining communication quality experienced by the electronic device with the communications network. Method 600 may include monitoring RTP packet loss of received data from the second electronic device. Method 600 may include determining that the RTP packet loss is greater than the RTP threshold value while a downlink communication quality detected by the electronic device is greater than a quality threshold value. In response to determining that RTP packet loss is greater than a RTP threshold value while the downlink communication quality detected by the electronic device is greater than a quality threshold value, method 600 includes generating and presenting a call quality notification, via the one or more output devices, indicating that a detected degraded quality of the digital protocol call session was influenced/affected by poor communication quality with the communications network experienced by a second electronic device that participated in the digital protocol call session and is beyond mitigation by adjusting the one or more local device parameters.

According to aspects of the present disclosure, the electronic device 100 (FIG. 1A), method 400 (FIG. 4), method 500 (FIG. 5), method 600 (FIG. 6), and computer program product, such as RSD 145 (FIG. 1A), provide techniques for proactively discovering and intervening when a user of the electronic device is dissatisfied with communication quality. The techniques include changing device parameter(s) that are associated with degraded communication quality in certain instances (e.g., audio volume, microphone selection, codec selection, etc.) to improve subsequent communication quality. The intervention may include identifying factor(s) external to the electronic device (e.g., uplink channel quality experienced at the far end by a second electronic device), informing the user as to the appropriate cause of the user dissatisfaction. Proactively discovering and intervening to address customer dissatisfaction by automatically adjusting device parameter(s) improves communication quality of a subsequent call, improving the user experience. Improving the user experience may financially benefit the original equipment manufacturers (OEMs) by reducing returns and increasing future purchases. The improved user experience may result in avoiding an inconvenience to the users who may otherwise return a properly functioning electronic device. Improving the user experience may generate additional good will for vendors, carriers, and OEMs associated with providing digital protocol calls.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device, comprising:
one or more input devices;
one or more output devices;
a communications subsystem by which the electronic device communicatively connects via a communications network to a video/voice call with one or more second electronic devices;
a memory comprising: (i) a user experience call improvement (UECI) module; and (ii) call session settings; and
a processor communicatively coupled to the one or more input devices, one or more output devices, the communications subsystem, and the memory, and which is configured to cause the electronic device to:
in response to detecting termination of a digital protocol call session with at least one second electronic device among the one or more second electronic devices, the digital protocol call session completed via the communications subsystem using first call session settings:
generate and present, via the one or more output devices, a customer satisfaction user interface comprising a satisfaction rating affordance for receiving a user satisfaction rating of the digital protocol call session; and
in response to receiving, via the one or more input devices, a user input to the satisfaction rating affordance indicating being less than fully satisfied with a previous digital protocol call session:
trigger performance of a local device check of device parameters that are associated with call quality of the previous digital protocol call session;
identify one or more device parameters to adjust in an attempt to improve future call quality in response to the user input indicating being less than fully satisfied; and
autonomously adjust the one or more device parameters during a subsequent digital protocol call session.

2. The electronic device of claim 1, wherein the processor is further configured to cause the electronic device to generate and present, via the one or more output devices, a notification indicating an autonomous adjustment of the one or more device parameters in response to the user input indicating being less than fully satisfied.

3. The electronic device of claim 1, wherein the one or more device parameters comprises audio volume and in autonomously adjusting the one or more device parameters during the subsequent digital protocol call session, the processor is further configured to cause the electronic device to:
determine whether an audio volume setting of the one or more output devices is less than a maximum setting; and
in response to determining that an audio volume setting of the one or more output devices is less than a maximum setting, increase the audio volume setting.

4. The electronic device of claim 1, wherein the one or more device parameters comprises coder/encoder (codec) selection, and in autonomously adjusting the one or more device parameters during the subsequent digital protocol call session, the processor is further configured to cause the electronic device to:
determine that the digital protocol call session used a first bandwidth codec; and
in response to determining that the digital protocol call session used the first bandwidth codec, configure the electronic device to utilize a second bandwidth codec for the subsequent digital protocol call session, the second bandwidth codec having a wider bandwidth than the first bandwidth codec.

5. The electronic device of claim 1, wherein the one or more device parameters comprises microphone selection, in autonomously adjusting the one or more device parameters during the subsequent digital protocol call session, the processor is further configured to cause the electronic device to:
in response to determining that the one or more input devices comprises more than one microphone comprising a first microphone that was used and a second microphone that was not used during the digital protocol call session, configure the electronic device to use the second microphone during the subsequent digital protocol call session.

6. The electronic device of claim 5, wherein the one or more device parameters comprises microphone selection, in autonomously adjusting the one or more device parameters during the subsequent digital protocol call session, the processor is further configured to cause the electronic device to:
determine that the one or more input devices comprises only a first microphone that was used during the digital protocol call session;
identify that the electronic device can be communicatively coupled to an external second microphone;
present a notification, via the one or more output devices, to connect the second microphone to the electronic device; and
configure the electronic device to use the connected second microphone for the subsequent digital protocol call session.

7. The electronic device of claim 1, wherein the one or more device parameters comprises radio access technology (RAT) network entity selection, in autonomously adjusting the one or more device parameters during the subsequent digital protocol call session, the processor is further configured to cause the electronic device to:
communicatively connect, via the communications subsystem, with a first RAT network entity during the digital protocol call session; and
in response to determining that a second RAT network entity within a connection range of the electronic device satisfies communication quality criteria for a handover, autonomously adjust the one or more device parameters during the subsequent digital protocol call session by triggering handover of the digital protocol call session to the second RAT network entity for the subsequent digital protocol call session.

8. The electronic device of claim 1, wherein, the processor is further configured to cause the electronic device to:
determine communication quality experienced by the electronic device with the communications network;
monitor real time protocol (RTP) packet loss of received data from the second electronic device;
determine that the RTP packet loss is greater than a RTP threshold value while a downlink communication quality detected by the electronic device is greater than a quality threshold value; and
in response to determining that RTP packet loss is greater than a RTP threshold value while the downlink communication quality detected by the electronic device is greater than a quality threshold value, generate and present a call quality notification, via the one or more output devices, indicating that a detected degraded quality of the digital protocol call session was influenced/affected by poor communication quality with the communications network experienced by a second electronic device that participated in the digital protocol call session and is beyond mitigation by adjusting the one or more device parameters.

9. The electronic device of claim 1, wherein the processor is further configured to cause the electronic device to:
in response to determining that subsequent digital protocol call session is being initiated in a second location that is different from a first location of the digital protocol call session, reset the call session setting to first default settings.

10. The electronic device of claim 1, wherein the processor is further configured to cause the electronic device to:
start an adjusted setting timer, contemporaneously with autonomously adjusting the one or more device parameters in preparation for the subsequent digital protocol call session; and
in response to expiration of the adjusted setting timer, remove the adjustment of the one or more device parameters.

11. The electronic device of claim 1, wherein the processor is further configured to cause the electronic device to:
in response to determining that the subsequent digital protocol call session is being initiated:
monitor communication quality associated with the adjustment of the one or more device parameters; and
remove the adjustment of the one or more device parameters in response to the communication quality being degraded below a quality threshold.

12. The electronic device of claim 1, wherein the processor is further configured to cause the electronic device to:
in response to determining that the subsequent digital protocol call session is being terminated:
generate and present, via the one or more output devices, a second customer satisfaction user interface comprising a second satisfaction rating affordance for receiving a second user satisfaction rating of the subsequent digital protocol call session; and
in response to receiving, via the one or more input devices, a second user input to the second satisfaction rating affordance indicating being less than fully satisfied, remove the adjustment of the one or more device parameters.

13. The electronic device of claim 12, wherein the processor is further configured to cause the electronic device to:
in response to the communication quality being degraded below a quality threshold:
trigger performance of a local device check of device parameters that are associated with call quality of the previous digital protocol call session:
identify one or more second device parameters to adjust in an attempt to improve future call quality in response to the user input indicating being less than fully satisfied; and
autonomously adjust the one or more second device parameters during a second subsequent digital protocol call session.

14. A method, comprising:
in response to detecting termination of a digital protocol call session with at least one second electronic device among one or more second electronic devices, the digital protocol call session completed via a communications subsystem of an electronic device using first call session settings:
generating and presenting, via one or more output devices, a customer satisfaction user interface comprising a satisfaction rating affordance for receiving a user satisfaction rating of the digital protocol call session; and
in response to receiving, via one or more input devices, a user input to the satisfaction rating affordance indicating being less than fully satisfied with a previous digital protocol call session:
triggering performance of a local device check of device parameters that are associated with call quality of the previous digital protocol call session;
identifying one or more device parameters to adjust in an attempt to improve future call quality in response to the user input indicating being less than fully satisfied;
autonomously adjusting the one or more device parameters during a subsequent digital protocol call session; and
generating and presenting, via the one or more output devices, a notification indicating an autonomous adjustment of the one or more device parameters in response to the user input indicating being less than fully satisfied.

15. The method of claim 14, wherein autonomously adjusting the one or more device parameters comprises audio volume during the subsequent digital protocol call session further includes:
determining whether an audio volume setting of the one or more output devices is less than a maximum setting; and
in response to determining that an audio volume setting of the one or more output devices is less than a maximum setting, increasing the audio volume setting.

16. The method of claim 14, wherein autonomously adjusting the one or more device parameters comprising coder/encoder (codec) selection during the subsequent digital protocol call session further comprises:
determining that the digital protocol call session used a first bandwidth codec; and
in response to determining that the digital protocol call session used the first bandwidth codec, configuring the electronic device to utilize a second bandwidth codec for the subsequent digital protocol call session, the second bandwidth codec having a wider bandwidth than the first bandwidth codec.

17. The method of claim 14, wherein autonomously adjusting the one or more device parameters comprising microphone selection during the subsequent digital protocol call session further comprises:
in response to determining that the one or more input devices comprises more than one microphone comprising a first microphone that was used and a second microphone that was not used during the digital protocol call session, configuring the electronic device to use the second microphone during the subsequent digital protocol call session; and
in response to determining that the one or more input devices comprises only a first microphone that was used during the digital protocol call session:
identifying that the electronic device can be communicatively coupled to an external second microphone;
presenting a notification, via the one or more output devices, to connect the second microphone to the electronic device; and
configuring the electronic device to use the connected second microphone for the subsequent digital protocol call session.

18. The method of claim 14, wherein autonomously adjusting the one or more device parameters comprising radio access technology (RAT) network entity selection during the subsequent digital protocol call session further comprises:
communicatively connecting, via the communications subsystem, with a first RAT network entity during the digital protocol call session; and
in response to determining that a second RAT network entity within a connection range of the electronic device satisfies communication quality criteria for a handover, autonomously adjusting the one or more device parameters during the subsequent digital protocol call session by triggering handover of the digital protocol call session to the second RAT network entity for the subsequent digital protocol call session.

19. The method of claim 14, further comprising:
determining communication quality experienced by the electronic device with a communications network;
monitoring real time protocol (RTP) packet loss of received data from the second electronic device;
determining that the RTP packet loss is greater than a RTP threshold value while a downlink communication quality detected by the electronic device is greater than a quality threshold value; and
in response to determining that RTP packet loss is greater than a RTP threshold value while the downlink communication quality detected by the electronic device is greater than a quality threshold value, generating and presenting a call quality notification, via the one or more output devices, indicating that a detected degraded quality of the digital protocol call session was influenced/affected by poor communication quality with the communications network experienced by a second electronic device that participated in the digital protocol call session and is beyond mitigation by adjusting the one or more device parameters.

20. A computer program product comprising:
a computer readable storage device; and
program code on the computer readable storage device that when executed by a processor associated with an electronic device, the program code is configured to cause the electronic device to provide functionality of:
in response to detecting termination of a digital protocol call session with at least one second electronic device among one or more second electronic devices, the digital protocol call session completed via a communications subsystem of an electronic device using first call session settings:
generating and presenting, via one or more output devices, a customer satisfaction user interface comprising a satisfaction rating affordance for receiving a user satisfaction rating of the digital protocol call session; and
in response to receiving, via one or more input devices, a user input to the satisfaction rating affordance indicating being less than fully satisfied with a previous digital protocol call session:
triggering performance of a local device check of device parameters that are associated with call quality previous digital protocol call session;
identifying one or more device parameters to adjust in an attempt to improve future call quality in response to the user input indicating being less than fully satisfied;
autonomously adjusting the one or more device parameters during a subsequent digital protocol call session; and
generating and presenting, via the one or more output devices, a notification indicating an autonomous adjustment of the one or more device parameters in response to the user input indicating being less than fully satisfied.
